(19) United States
(12) Patent Application Publication
(10) Pub. No.: US 2017/0151881 A1
(43) Pub. Date: Jun. 1, 2017

(54) BATTERY REPLACEMENT SYSTEM FOR ELECTRIC VEHICLE AND METHOD OF USING THE BATTERY REPLACEMENT SYSTEM

(71) Applicant: HON HAI PRECISION INDUSTRY CO., LTD., New Taipei (TW)

(72) Inventor: CHIA-YEN LEE, New Taipei (TW)

(21) Appl. No.: 14/982,858

(22) Filed: Dec. 29, 2015

(30) Foreign Application Priority Data
Nov. 30, 2015 (TW) 104140009

(51) Int. Cl. B60L 11/18; B60G 17/04; G05D 1/02; B60S 5/06

(52) U.S. Cl. CPC B60L 11/1822; B60S 5/06; B60G 17/0416; G05D 1/0276

(57) ABSTRACT

A battery replacement system configured to replace battery for an electric vehicle includes a control system, a first self-propelled battery module and a second self-propelled battery module in communication with the control system. The first self-propelled battery module is configured to detach from the electric vehicle upon receiving an appropriate command from the control system, and second self-propelled battery module is configured to be mounted to the electric vehicle upon receiving an appropriate command from the control system. The first self-propelled battery module and the second self-propelled battery module are capable of moving automatically to an predetermined position. An using method of the battery replacement system is also provided.

### FIELD

The subject matter herein generally relates to a battery replacement system for electric vehicle, and a method of using the battery replacement system.

### BACKGROUND

Battery pack is configured to supply power to motor of an electric vehicle. When the amount of charge of the battery pack is less than or equal to a predetermined amount, the battery pack needs to charged while remaining in the vehicle, or the spent battery pack needs to be replaced by a fully charged battery.

### BRIEF DESCRIPTION OF THE DRAWINGS

Implementations of the present technology will now be described, by way of example only, with reference to the attached figures.

FIG. 1 is a block diagram of one example of a battery replacement system for electric vehicle.

FIG. 2 is a diagrammatic view of one example of the battery replacement system shown in FIG. 1.

FIG. 3 is a diagrammatic view of a second self-propelled battery module shown in FIG. 2.

FIG. 4 is a block diagram of the second self-propelled battery module as shown in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as coupled, whether directly or indirectly through intervening components, and is not necessarily limited to physical connections. The connection can be such that the objects are permanently coupled or releastably coupled. The term “comprising” when utilized, means “including, but not necessarily limited to”; it specifically indicates open-ended inclusion or membership in the so-described combination, group, series and the like.

The present disclosure is described in relation to a self-propelled battery module and an electric vehicle including the self-propelled battery module.

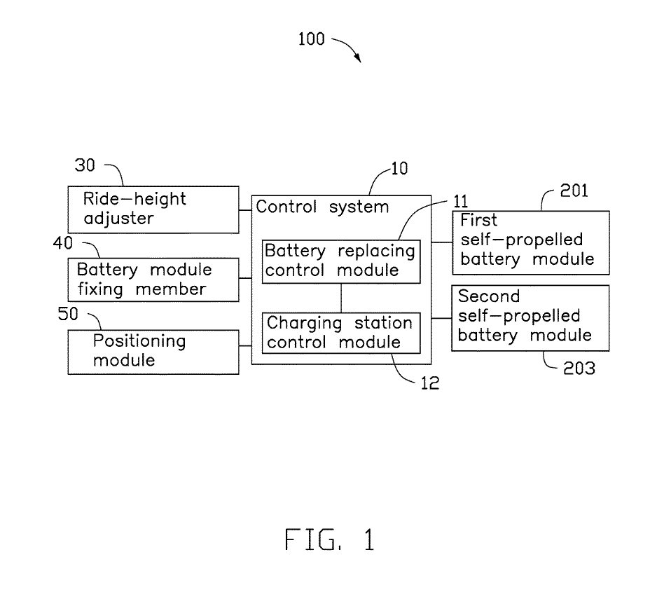

FIG. 1 illustrates that a battery replacement system 100 can include a control system 10, a first self-propelled battery module 201, a second self-propelled battery module 203, a ride-height adjuster 30, a battery fixing member 40, and a positioning module 50. The control system 10 can include a battery replacing control module 11 and a charging station control module 12. The ride-height adjuster 30, the battery fixing member 40, and the positioning module 50 can be electrically coupled to the control system 10. The first self-propelled battery module 201 and the second self-propelled battery module 203 can be in communication with the control system 10. In at least one embodiment, the first self-propelled battery module 201 and the second self-propelled battery module 203 can establish a wireless link with the control system 10.

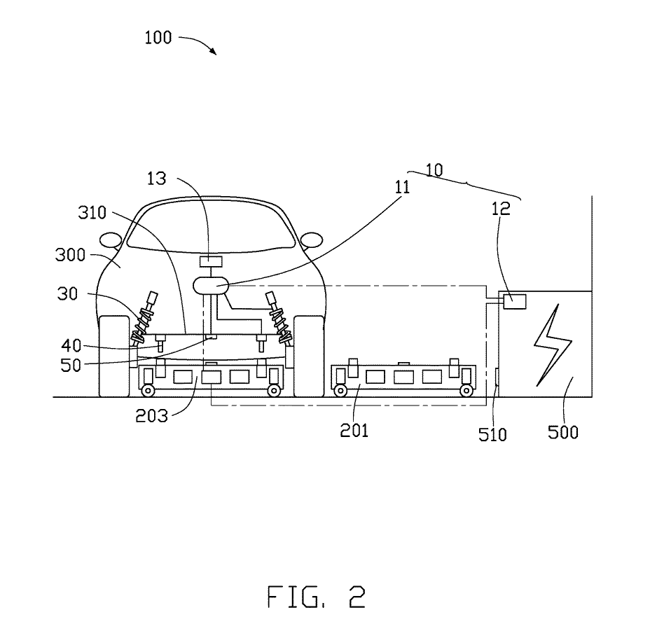

FIG. 2 illustrates that the battery replacement system 100 can be used to replace battery for an electric vehicle 300. The electric vehicle 300 can include a chassis 310. In illustrated embodiment, the first self-propelled battery module 201 has less energy, and the second self-propelled battery module 203 has been charged to have enough energy. The first self-propelled battery module 201 can be detached from the chassis 310 of the electric vehicle 300 and move automatically to a charging station 500 upon receiving an appropriate command from the control system 10. The second self-propelled battery module 203 can stay in the charging station 300 to be directed. The second self-propelled battery module 203 can be mounted to the electric vehicle 300 upon receiving an appropriate command from the control system 10. The first self-propelled battery module 201 and the second self-propelled battery module 203 are capable of moving automatically, so the first self-propelled battery module 201 and the second self-propelled battery module 203 can move between the electric vehicle 300 and the charging station 500. The charging station 500 can include a charger 510.

The control system 10 can be configured to control the first self-propelled battery module 201 and the second self-propelled battery module 203. The battery replacing control module 11 can be mounted on the electric vehicle 300, the charging station control module 12 can be mounted on the charging station 500, and the battery replacing control module 11 can be in communication with the charging station control module 12. The control system 10 can further include a battery replacing interface 13. The battery replacing interface 13 can be configured to input an battery replacing order, and transmit a battery replacing signal to the battery replacing control module 11.

The battery replacing control module 11 can be configured to receive the battery replacing signal and send the battery replacing signal to the charging station control module 12. The battery replacing control module 11 can be electrically connected to the ride-height adjuster 30, the battery fixing member 40, and the positioning module 50. The battery replacing control module 11 can be in communication with the first self-propelled battery module 201 and the second self-propelled battery module 203.

The charging station control module 12 can be in communication with the first self-propelled battery module 201 and the second self-propelled battery module 203 and configured to control activations of the first self-propelled battery module 201 and the second self-propelled battery module 203. The charging station control module 12 can be configured to receive the battery replacing signal, and send a starting signal to the second self-propelled battery module 203 which is full charged and positioned in the charging station 500. The second self-propelled battery module 203 can move automatically to the electric vehicle 300 after receiving the starting signal. The charging station control module 12 can be further configured to send a charging control signal to the first self-propelled battery module 201, thus the first self-propelled battery module 201 can move automatically to the charging station 500 for charging.

The ride-height adjuster 30 can be controlled by the control system 10 and configured to automatically adjust the ride height of the electric vehicle 300. When detaching the first self-propelled battery module 201, the ride-height adjuster 30 can raise the vehicle body of the electric vehicle 300 relative to the ground. After the second self-propelled battery module 203 is positioned below the chassis 310 of the electric vehicle 300, the ride-height adjuster 30 can lower the ride height of the electric vehicle 300 to an initial height. The ride-height adjuster 30 can include a pneumatic suspension system or a hydraulic suspension system, and the height of the vehicle body can be adjusted by the pneumatic/hydraulic suspension system. In other embodiments, the ride-height adjuster 30 can be other driving mechanism adapter for vehicle.

The battery fixing member 40 can be controlled by the control system 10 and configured to couple the first self-propelled battery module 201 and the second self-propelled battery module 203, thereby the first self-propelled battery module 201 and the second self-propelled battery module 203 can be mounted on the electric vehicle 300 or disassembled from the electric vehicle 300.

The vehicle positioning module 50 can be configured to sense if the second self-propelled battery 203 is located below the electric vehicle 300 and send a sensing signal to the battery replacing control module 11. The battery replacing control module 11 can control the battery fixing member 40 to connect with the second self-propelled battery 203 after receiving the sensing signal.

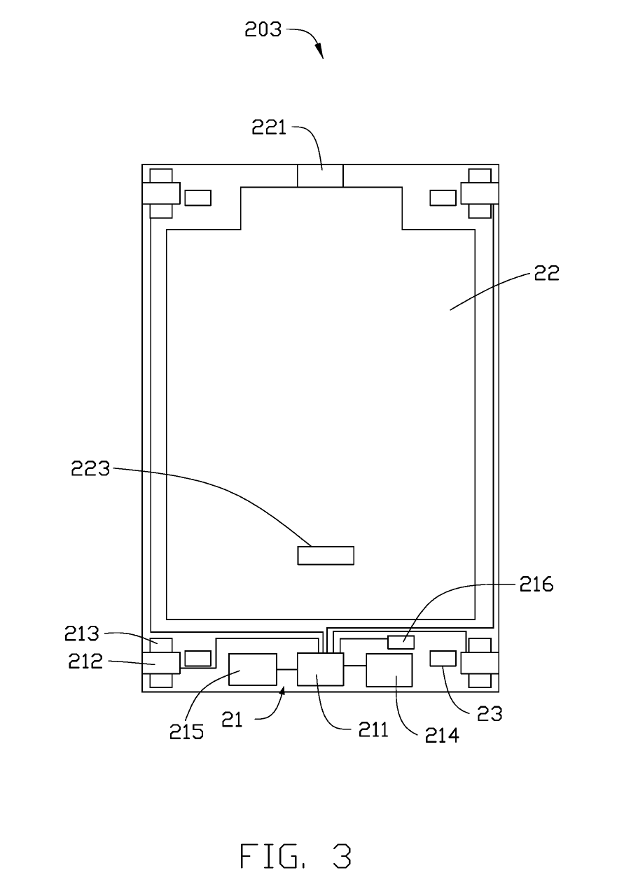

FIG. 3 illustrates that the second self-propelled battery module 203 can include a travelling controller 21 assembled together with a rechargeable battery 22. The rechargeable battery 22 can be configured to supply electric power to the electric vehicle 300. The rechargeable battery 22 can couple with a battery controlling system (not shown) in the electric vehicle 300. The rechargeable battery 22 can include a charge interface 221 and a power supply interface 223. The charge interface 221 can be coupled to a charging interface (not shown) of the charging station 300, and the power supply interface 223 can be coupled to the battery controlling system in the electric vehicle 300.

The second self-propelled battery module 203 can further include at least one battery connecting member 23. The battery connecting member 23 can be coupled to the battery module fixing member 40 of the electric vehicle 300. In at least one embodiment, there are four battery connecting members 23, and the four battery connecting members 23 can be positioned at four corners of the second self-propelled battery module 203.

The travelling controller 21 can include a control unit 211, a driving unit 212, a travelling wheel 213, a battery unit 214, a sensing unit 215, and a positioning unit 216. The driving unit 212, the battery unit 214, the sensing unit 215, and the positioning unit 216 can be electrically connected to the control unit 211.

In at least one embodiment, there can be four travelling wheels 213, and the four travelling wheels 213 are respectively positioned at four corners of the self-propelled battery module 20. There can also be four driving units 212. The travelling wheel 213 can be wheel type or crawler-type, and the driving unit can be any driving mechanism adapted for driving the travelling wheel 213.

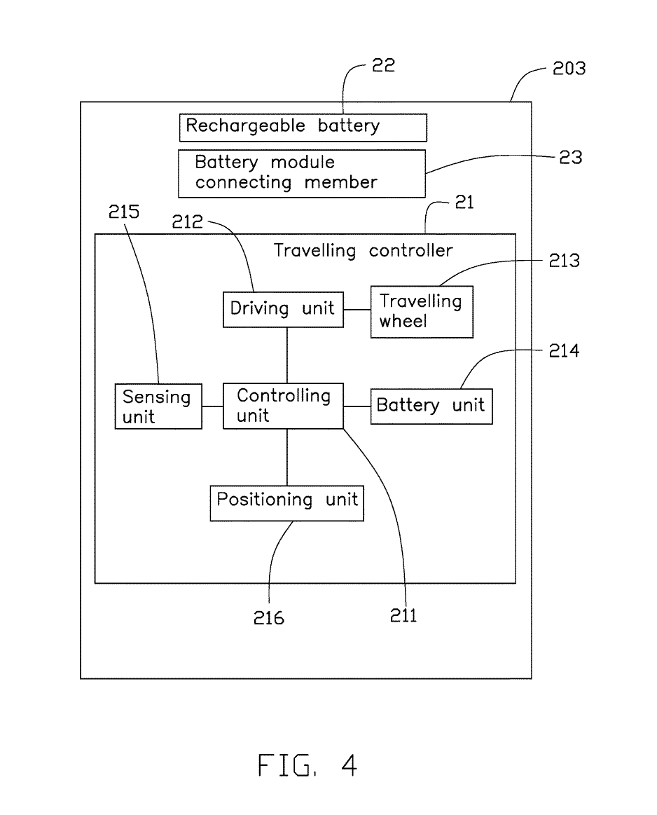

FIG. 4 illustrates that the travelling wheel 213 can be connected to the corresponding driving unit 212.

The control unit 211 can storage route data of the charging station 500. The sensing unit 215 can be configured to transmit and receive sound ranging signal for distance measuring, and feedback a distance signal to the control unit 211. Thus, a distance between the second self-propelled battery module 203 in the charging station 500 and the electric vehicle 300 adjacent to the charging station 300 can be measured. The control unit 211 can calculate the distance signal from the sensing unit 215 based on the existing route data for real time routing optimization. Then, the control unit 211 can obtain an optimized route and then transmit an optimized route signal and electric power to the driving unit 212.

The driving unit 212 can be configured to receive the optimized route signal from the control unit 211 and drive the travelling wheel 213 to rotate, thus the self-propelled battery module 20 can move following the optimized route.

The positioning unit 216 can be configured to measure a position deviation between the second self-propelled battery module 203 and the electric vehicle 300, and transmit a signal of the position deviation to the control unit 211. The control unit 211 can transmit the signal of the position deviation to the driving unit 212, and the travelling wheel 213 can rotate to adjust the location of the self-propelled battery module 20, thereby the second self-propelled battery module 203 can move to a precise position below the electric vehicle 300.

The battery unit 214 can supply electric power to the driving unit 212 through the control unit 211.

The first self-propelled battery module 201 can be same with the second propelled battery module 203, and the first self-propelled battery module 201 can also include the travelling controller 21 and the rechargeable battery 22.

An example method of using the battery replacement system 100 is provided by way of example, as there are a variety of ways to carry out the method. The method described below can be carried out using the configurations illustrated in FIG. 1 through FIG. 4, for example, and various elements of these figures are referenced in explaining example method.

The control system 10 can be started, and the first self-propelled battery module 201 can be detached from the electric vehicle 300 controlled by the control system 10. Then, the first self-propelled battery module 201 can move automatically to the charging station 500 for charging upon receiving the appropriate command from the control system 10. The second self-propelled battery module 203 can move automatically to the electric vehicle 300 upon receiving the appropriate command from the control system 10. Then the second self-propelled battery module 203 can be mounted to the electric vehicle 300. In at least one embodiment, the first second self-propelled battery module 201 and the second self-propelled battery module 203 can move at the same time. In other embodiments, the first self-propelled battery module 201 can move to a first designated position for charging other than the charging station 500, and the second self-propelled battery module 203 can move to a second designated position of the electric vehicle 300 other than the chassis 310.

Specifically, the user can drive the electric vehicle 300 to the charging station 500 and input the battery replacing order by the battery replacing interface 13. The battery replacing interface 13 can transmit the battery replacing signal to the battery replacing control module 11. The battery replacing control module 11 can transmit battery replacing signal to the charging station control module 12. The ride-height adjuster 30 can raise the ride height of the electric vehicle 300, and the battery fixing member 40 can unlock the first self-propelled battery module 201 and release the first self-propelled battery module 201 on the ground. Then, the charging station control module 12 can transmit the charging control signal to the first self-propelled battery module 201, and the first self-propelled battery module 201 can move automatically toward the charging station 500 and then be charged in the charging station 500.

The charging station control module 12 can transmit the starting signal to the second self-propelled battery module 203 in the charging station 500. The sensing unit 215 of the second self-propelled battery module 203 can measure the distance between the second self-propelled battery module 203 and the electric vehicle 300, and send the distance signal to the control unit 211. The control unit 211 can calculate the signal from the sensing unit 215 based on the existing route data to obtain an optimized route, and transmit the optimized route date to the driving unit 212. The travelling wheel 213 can rotate automatically to the electric vehicle 300 driven by the driving unit 212.

The sensing unit 216 can measure the position deviation between the second self-propelled battery module 203 and the electric vehicle 300, and transmit the signal of the position deviation to the control unit 211. The control unit 211 can transmit the signal of the position deviation to the driving unit 212, thus the travelling wheel 213 can move until the self-propelled battery module 20 aligns with to the chassis of the electric vehicle 300. After the positioning module 50 verifies that the second self-propelled battery module 203 is located at the designated position, the control system 10 can transmit a control signal to the battery fixing member 23, and the battery fixing member 23 can couple with the second self-propelled battery module 203, thereby the second self-propelled battery module 203 can be mounted to the electric vehicle 300. The recharge battery 22 can supply electric power to the electric vehicle, and then the ride-height adjuster 30 can lower the ride height to the initial state controlled by the control system 10.

In other embodiments, the battery connecting member 23 can be omitted, and the self-propelled battery module 20 can be clamped by the battery fixing member 40.

In other embodiments, the number of the travelling wheels 213 can be two or more, or the number of the travelling wheel 213 can be one, as long as the self-propelled battery module 20 can move smoothly.

In other embodiments, the positioning module 50 can be omitted. The positioning unit 216 can transmit a positioning signal to the control unit 211, and the control unit 211 can transmit the positioning signal to the battery replacing control module 11.

In other embodiments, the ride-height adjuster 30 can be omitted if the height of the chassis 310 is high enough, and the first self-propelled battery module 201 can pass through the chassis 310.

The first self-propelled battery module 201 and the second self-propelled battery module 203 can move automatically to the electric vehicle 300, the charging station 300 or other charging facility. There is no need to build special swapping facility. The battery replacement system 100 can replace the recharge batteries quickly and with high automation. Moreover, the recharge battery 22 of the self-propelled battery module 20 can be replaced with different kinds of batteries to meet demand of different kinds of electric vehicles, and the self-propelled battery module 20 can be widely used.

The embodiments shown and described above are only examples. Many details are often found in the art such as the other features of a battery replacement system and a method of using the battery replacement system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A battery replacement system configured to replace battery for an electric vehicle, the battery replacement system comprising:
a control system;
a first self-propelled battery module in communication with the control system;
a second self-propelled battery module in communication with the control system;
wherein the first self-propelled battery module is configured to detach from the electric vehicle upon receiving an appropriate command from the control system, and second self-propelled battery module is configured to be mounted to the electric vehicle upon receiving an appropriate command from the control system; and
wherein the first self-propelled battery module and the second self-propelled battery module are capable of moving automatically to an predetermined position.

2. The battery replacement system as claimed in claim 1, wherein the battery replacement system further comprises a battery module fixing member electrically connected to the control system, and the battery module fixing member is configured to detach the first self-propelled battery module from the electric vehicle and mount the second self-propelled battery module to the electric vehicle.

3. The battery replacement system as claimed in claim 2, wherein the first self-propelled battery module and the second self-propelled battery module each comprises a battery module connecting member and the battery module connecting member configured to couple with the battery module fixing member.

4. The battery replacement system as claimed in claim 1, wherein the battery replacement system further comprises a ride-height adjuster mounted on the electric vehicle, the ride-height adjuster being electrically connected to the control system and configured to adjust an height of the electric vehicle body.

5. The battery replacement system as claimed in claim 1, wherein the battery replacement system further comprises a positioning module mounted on the electric vehicle, the positioning module being electrically connected to the control system, and the positioning module being configured to sense the position of the second self-propelled battery module below the electric vehicle and send a sensing signal to the control system.

6. The battery replacement system as claimed in claim 1,
wherein the control system comprises a battery replacing control module and a charging station control module both in communication with the battery replacing control module; and
wherein the battery replacing control module is configured to send a battery replacing signal to the charging station control module, and the charging station control module is configured to control activations of the first self-propelled battery module and the second self-propelled battery module.

7. The battery replacement system as claimed in claim 6,
wherein the charging station control module is configured to send a starting signal to the second self-propelled battery module, and the second self-propelled battery module moves to the electric vehicle upon receiving the starting signal; and
wherein the charging station control module is further configured to send a charging control signal to the first self-propelled battery module, and the first self-propelled battery module moves to a charging station upon receiving the charging control signal.

8. The battery replacement system as claimed in claim 6, wherein the control system further comprises a battery replacing interface electrically connected to the battery replacing control module, and the battery replacing interface is configured to input a battery replacing order and transmit the battery replacing signal to the battery replacing control module.

9. The battery replacement system as claimed in claim 1,
wherein the first self-propelled battery module and the second self-propelled battery module each comprises a rechargeable battery and a travelling controller assembled together with the rechargeable battery, and the rechargeable battery is configured to supply electric power to the electric vehicle;
wherein the travelling controller comprises a control unit, a driving unit electrically connected to the control unit, and a travelling wheel connected to the driving unit; and
wherein the control unit is configured to transmit control signal to the driving unit, and the driving unit is configured to receive the control signal from the control unit and drive the travelling wheel to rotate, and the self-propelled battery is capable of moving automatically.

10. The battery replacement system as claimed in claim 9,
wherein each of the first self-propelled battery module and the second self-propelled battery module further comprises a positioning unit, the positioning unit is configured to detect a position deviation between the self-propelled battery module and the electric vehicle and transmit a signal of the position deviation to the control unit; and
wherein the control unit is further configured to transmit the signal of the position deviation to the driving unit.

11. The battery replacement system as claimed in claim 9, wherein each of the first self-propelled battery module and the second self-propelled battery module further comprises a sensing unit, and the sensing unit is configured to measure a distance between the self-propelled battery module and the electric vehicle, and transmit a distance signal to the control unit.

12. The battery replacement system as claimed in claim 11, wherein the control unit storage route data, the control unit is further configured to process the distance signal based on the route data to obtain an optimized route, and transmit an optimized route signal to the driving unit.

13. The battery replacement system as claimed in claim 9, wherein each of the first self-propelled battery module and the second self-propelled battery module further comprises a battery unit electrically connected to the control unit, and the battery unit is configured to supply electric power to the driving unit through the control unit.

14. The battery replacement system as claimed in claim 9, wherein the travelling controller comprises four driving units and four travelling wheels, each driving unit is electrically connected to the control unit, and each travelling wheel is connected to the corresponding driving unit.

15. A battery replacement system configured to replace battery for an electric vehicle, the battery replacement system comprising:
a first self-propelled battery module being capable of moving automatically to an predetermined position and configured to be detached from the electric vehicle;
a second self-propelled battery module being capable of moving automatically to a pre-set position and configured to be mounted to the electric vehicle; and
a battery module fixing member is configured to detach the first self-propelled battery module from the electric vehicle and mount the second self-propelled battery module to the electric vehicle.

16. The battery replacement system as claimed in claim 15, wherein the battery replacement system further comprises a ride-height adjuster mounted on the electric vehicle, the ride-height adjuster being electrically connected to the control system and configured to adjust an height of the electric vehicle body.

17. The battery replacement system as claimed in claim 15, wherein the battery replacement system further comprises a control system in communication with the first self-propelled battery module and the second self-propelled battery module, and the battery module fixing member is electrically connected to the control system.

18. The battery replacement system as claimed in claim 15,
wherein the first self-propelled battery module and the second self-propelled battery module each comprises a rechargeable battery and a travelling controller assembled together with the rechargeable battery, and the rechargeable battery is configured to supply electric power to the electric vehicle;
wherein the travelling controller comprises a control unit, a driving unit electrically connected to the control unit, and a travelling wheel connected to the driving unit; and
wherein the control unit is configured to transmit control signal to the driving unit, and the driving unit is configured to receive the control signal from the control unit and drive the travelling wheel to rotate, and the self-propelled battery is capable of moving automatically.

19. A method of using the battery replacement system as claimed in claim 1, the method comprising:
starting the control system;
detaching the first self-propelled battery module form the electric vehicle;
controlling the first self-propelled battery module to move automatically to a first predetermined position;
controlling the second self-propelled battery module to move automatically to a second designated position of the electric vehicle; and
mounting the second self-propelled battery module to the electric vehicle.
